(19) United States
(12) Patent Application Publication
(10) Pub. No.: US 2020/0262589 A1
(43) Pub. Date: Aug. 20, 2020

(54) ATTITUDE RATE MITIGATION OF SPACECRAFT IN CLOSE PROXIMITY

(71) Applicant: Space Systems/Loral, LLC, Palo Alto, CA (US)

(72) Inventor: Eric Richard Turner, Livermore, CA (US)

(73) Assignee: Space Systems/Loral, LLC, Palo Alto, CA (US)

(21) Appl. No.: 16/276,987

(22) Filed: Feb. 15, 2019

(51) Int. Cl. B64G 1/24; B64G 1/26; B64G 1/10

(52) U.S. Cl. CPC B64G 1/242; B64G 2001/245; B64G 1/1078; B64G 1/26

(57) ABSTRACT

Technique for altering a client spacecraft's rotational rate including the precise positioning of a servicing spacecraft in close proximity of a client spacecraft, alignment of a fluid release output device on the servicing spacecraft that imparts a force on the client spacecraft by means of fluid release, and subsequent use of the fluid release output device to mitigate tumbling of the client spacecraft. This allows the servicing spacecraft to slow the rotation of a tumbling client spacecraft in order to perform additional servicing operations.

### BACKGROUND

On-orbit servicing is an operation where a servicing spacecraft will rendezvous with a secondary, or client, spacecraft, grapple and provide a variety of services to the secondary satellite, and depart. The servicing vehicles may provide anomaly resolution for spacecraft that are otherwise helpless. A variety of different anomalies can leave a spacecraft with a rotation rate that is unrecoverable, referred to as tumbling, without any sort of external help, where examples of this would include micro-meteoroid impact, thruster leakage, and failed sensors. To provide anomaly resolution services, a servicing spacecraft will generally first need to grapple the out-of-control spacecraft. In order to do this, the servicing spacecraft would likely have to perform a complicated and propellant expensive maneuver, or series of maneuvers, to match the tumbling spacecraft's rate. Even small tumbling rates are intensively demanding or are completely unattainable by the servicing vehicle, particularly due to distances between the tumbling spacecraft center of mass and grapple locations.

### BRIEF DESCRIPTION OF THE DRAWINGS

FIG. 1 illustrates a servicing spacecraft orbiting the Earth at a different location than a target spacecraft.

FIG. 2 illustrates the target spacecraft in an anomalous state and the start of the servicing spacecraft rendezvousing with the target spacecraft.

FIG. 3 illustrates a servicing spacecraft observing a tumbling target spacecraft once it is in proximity.

FIG. 4 illustrates the positioning of the servicing satellite and the alignment of its fluid release output.

FIG. 5 shows a plume of fluid from the servicing satellite impinging on the target satellite.

FIGS. 6 and 7 show two views of an embodiment for a servicing satellite.

FIG. 8 is a block diagram for an embodiment of servicing satellite's body.

FIG. 9 provides more detail on an embodiment of the propulsion subsystem.

FIGS. 10 and 11 respectively illustrate a servicing satellite positioning itself relative to a target satellite and operating a fluid release output to purposefully impinge a surface of the target satellite.

FIG. 12 is a flowchart illustrating an embodiment of a process for the use of a servicing satellite for a servicing mission for a client satellite.

FIGS. 13 and 14 are flowcharts providing more detail for embodiments of the flow of FIG. 12.

### DETAILED DESCRIPTION

The following presents techniques for controlling and reducing a tumbling spacecraft's rotation rate, making grappling both possible and less propellant expensive and thus increasing a servicing vehicle's capability to provide anomaly resolution services. As part of an on-orbit servicing mission for a client spacecraft, the servicing spacecraft will typically need to grapple with the targeted client spacecraft. To be able to readily grapple with the target spacecraft, the target spacecraft will need to be rotating at a fairly slow rate, such as tumbling at a rate of 0.5 deg/s or less. When the on-orbit servicing spacecraft, or servicer, has approached the second, or target, spacecraft with the intent of grappling on, however, the second spacecraft may be rotating at a rate that makes grappling impossible or extremely demanding from the servicer control system. To slow the target spacecraft's rotational rate to be within the capabilities of required performance for the servicing spacecraft, the servicing spacecraft positions itself at a safe standoff distance and in an orientation that allows the servicing spacecraft to operate a fluid release output (such as a thruster) that provides an impingement force onto a specified surface of the second spacecraft for the purposes of slowing the rate of rotation. In some cases, the attitude rate adjustment of the target spacecraft need not be followed by grappling the target spacecraft, but could serve as an anomaly resolution strategy in itself. By reducing the tumbling rate of the secondary spacecraft to a manageable rate, which may depend on the severity of the anomaly as well as the secondary spacecraft's design, the secondary spacecraft could regain control capability just through having its rotation rate sufficiently reduced.

The following discussion generally considers on-orbit attitude control of a client, or target, spacecraft by a servicing spacecraft. The described servicing will primarily be described in the context of the Robotic Servicing of Geosynchronous Satellites (RSGS) mission, but can also be applied to other on-orbit servicing, such as Low Earth Orbit (LEO) servicing. In the following, the terms “spacecraft”, “satellite” and “vehicle” may be used interchangeably and generally refer to any orbiting satellite or spacecraft system.

On-orbit servicing refers to the use of a servicing spacecraft for rendezvous with a second, client spacecraft, grappling and provision of a variety of services, and subsequent departure. One of the primary tasks of on-orbit servicing is the repair of spacecraft that have experienced a failure, this operation is referred to as anomaly resolution. A variety of different anomalies can cause a spacecraft to lose attitude control or to enter a rotation rate that is unrecoverable, referred to as tumbling. Examples of anomalies that can lead to tumbling include micro-meteoroid impact, thruster leakage, and failed attitude control sensors.

To provide the bulk of anomaly resolution services, a servicing vehicle first needs to grapple the out-of-control spacecraft. In order to do this, the servicing vehicle will likely have to perform a complicated and propellant expensive maneuver (or series of maneuvers) to match the tumbling spacecraft's rate. Even small tumbling rates are intensely demanding or are completely unattainable by the servicing vehicle, particularly due to possible distances between the tumbling spacecraft's center of mass and servicing vehicle's center of mass. These operations are inherently risky for a number of reasons, primarily because it involves the servicing vehicle entering a region of close proximity, where collision with a tumbling spacecraft's deployable devices is possible. Collision is considered to be an extremely hazardous event as it can produce debris that can pose a collision threat to other spacecraft. To reduce risk to the on-orbit servicing missions, it is important to consider methods that reduce risk of damage to servicing vehicles as well as other spacecraft.

The following presents techniques for altering a tumbling spacecraft's rotational rate, making grappling both possible and less propellant expensive, thus increasing the servicing vehicle's capability to provide anomaly resolution services. The servicing spacecraft uses an attitude rate alteration technique on the target spacecraft that enables the service spacecraft to alter the rate of rotation of the target spacecraft using the impingement force created as a result of the release of a plume or plumes of fluid from the servicing spacecraft. The servicing vehicle may already be orbiting in another location and be moved to be in proximity with a client, or may be launched for this purpose.

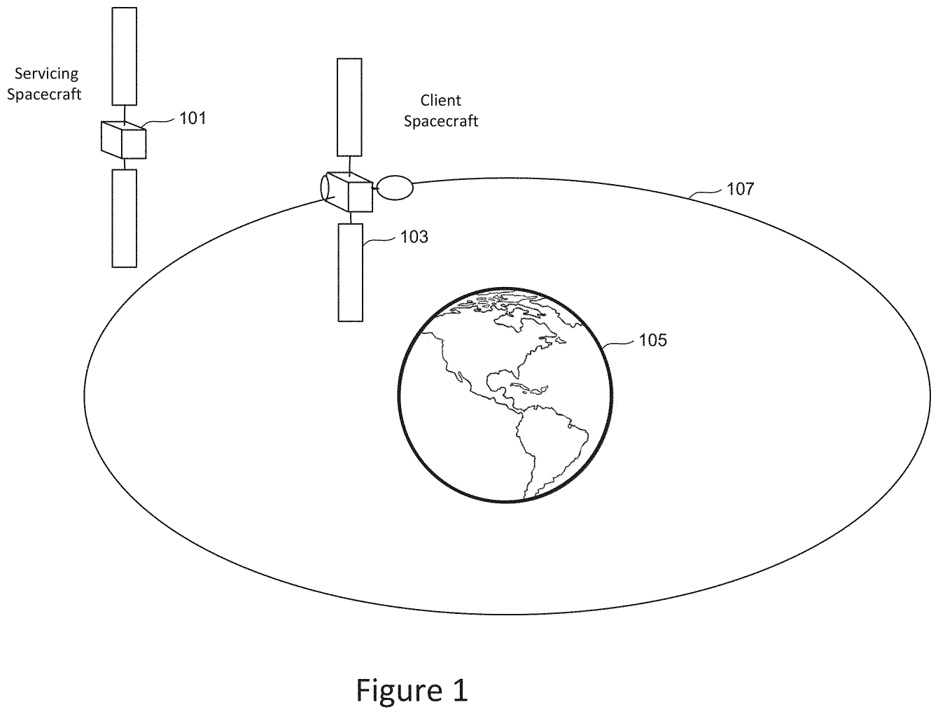

FIG. 1 illustrates an example of the general situation where a target spacecraft 103 is on an orbit 107 around the earth 105. A servicing spacecraft 101 targets the client spacecraft 103 to be serviced and performs a rendezvous sequence that positions the servicing spacecraft 101 to be in close proximity of the target spacecraft 103. In some examples, close proximity is on the order of tens of meters but is at a safe standoff distance that minimizes the risk of collision. Depending on the embodiment, the rendezvous sequence may be performed at various levels of autonomy. For example, the servicing spacecraft 101 can be given a position for the target spacecraft 103 and, after locating the target spacecraft 103, the servicing spacecraft 101 performs the rendezvous autonomously, while in other cases of the rendezvous can be partially or fully controlled from the ground.

A single robotic servicing satellite 101 can over the course of a single mission, perform rendezvousing and docking with a number of client target vehicles. Depending on the embodiment, a servicing satellite 101 can deliver a variety of services, such as inspection, anomaly resolution, refueling, repairs, and so on, and then depart from the client target satellite 103 to rendezvous with another client satellite.

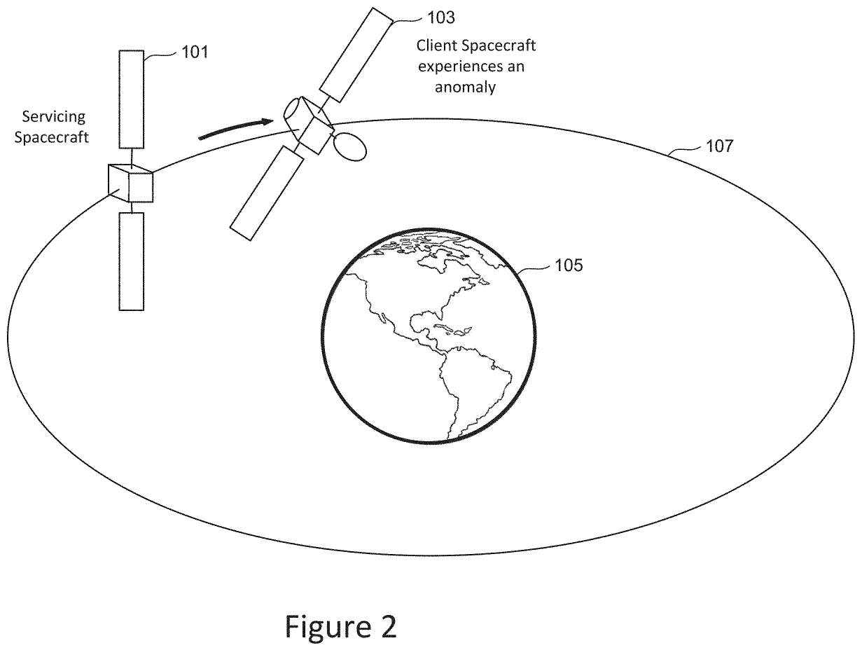

In some embodiments, the servicing spacecraft 101 observes the target spacecraft 103 for a period of time to evaluate the target spacecraft's overall state, including vehicle dynamics and physical configuration. The determination of the rotational rate of the target spacecraft 103 can be performed with different levels of autonomy, depending on the embodiment. FIG. 2 is a schematic representation of the servicing satellite 101 approaching a target satellite 103 that is tumbling, where tumbling can be defined as the uncontrolled rotation of a spacecraft about its own center of mass. Rendezvousing with a tumbling target satellite 103 is demanding on the control system of the servicing satellite 101 and, as a result, the rate at which a client spacecraft can be tumbling is constrained to 0.5 deg/s or less, for example. To reduce the tumbling rate of a target spacecraft 103, the servicing satellite 101 applies a plume of fluid to the target satellite. For example, the servicing satellite can purposefully impinge upon the solar array of the target satellite 103 using a thruster of the servicing satellite 101.

In some embodiments, the servicing spacecraft 101 positions itself in a relative orientation that aligns a fluid emitting device with a surface of the target spacecraft 103 while also positioning itself at a safe standoff distance that minimizes the risk of collision. This maneuver may be performed with varying levels of autonomy, depending on the embodiment. The servicing spacecraft 101 may operate a device that releases a fluid in a desired direction for the purposes of altering the dynamics of the target spacecraft 103, while maintaining its alignment with the target spacecraft 103. This operation could be either open loop or closed loop, depending on the level of implemented autonomy. In an open loop implementation of this technique, a specified period of operation of the fluid release output may either be dictated to the servicing spacecraft 101 from ground operators or stored as a preset value in onboard memory. The period may be preset or analyzed and determined on a case-by-case basis. In a closed loop implementation, the servicing spacecraft 101 may have the ability to autonomously evaluate the rotational rate of the target spacecraft 103 and may operate a fluid release output until it determines that the rotational rate of the target spacecraft 103 is reduced to be within a specified range. In some implementations, the specified range of rotational rates would correspond to the maneuvering capability of the servicing spacecraft for the purposes of grappling as well as the physical configuration of the target spacecraft.

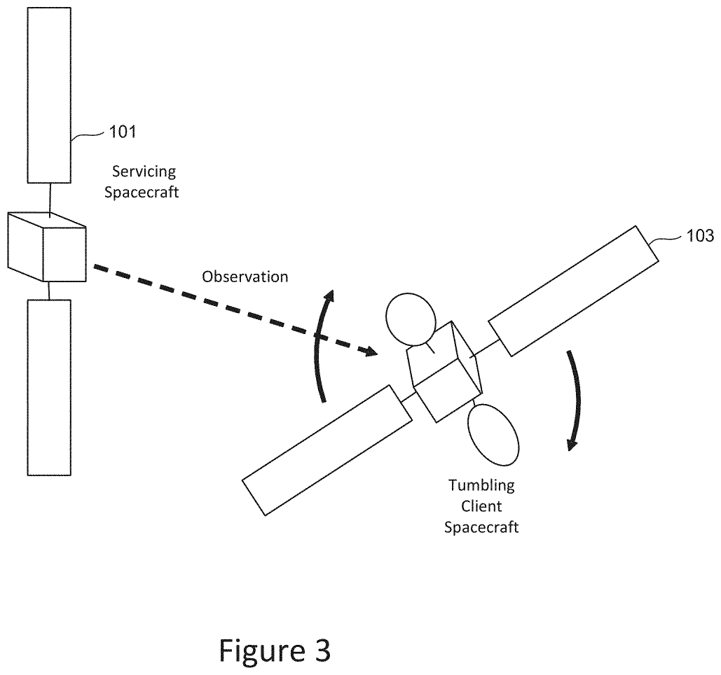

FIG. 3 illustrates a servicing spacecraft 101 observing a tumbling target spacecraft 103 once it is in proximity. To perform this observation, in addition to equipment for performing normal satellite operations and for the maintenance operations on a target satellite, the servicing satellite 101 can be equipped with a control system that can include of 6 degree-of-freedom thruster control, cameras (which can include infra-red and visible light), optics, LiDAR (light detection and ranging), star trackers, reaction wheels, accelerometers, and gyroscopes coupled with autonomous Rendezvous and Proximity Operations (RPO) software (such as that designed by the Charles Stark Draper Laboratories), for example. With this sensor suite and software, a servicing satellite 101 can have the capability of precise relative navigation when in close proximity to a target spacecraft 103.

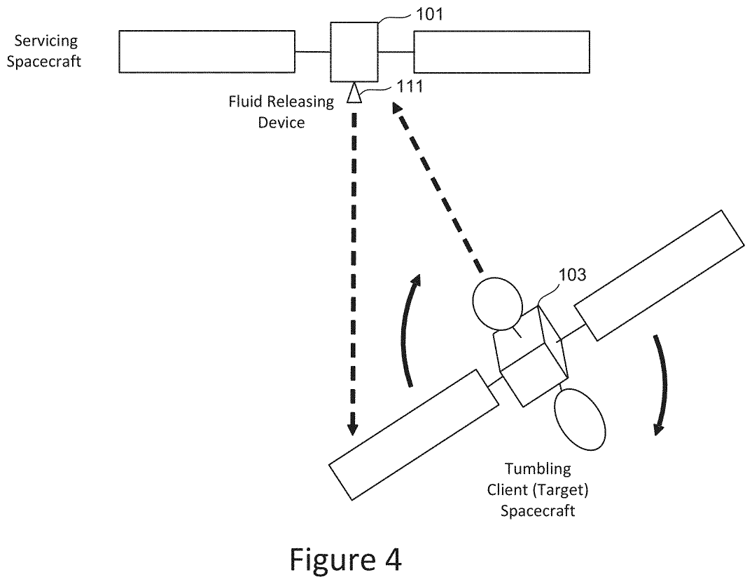

Using relative navigation, the servicing satellite 101 can position itself at a safe standoff distance and align itself with respect to the target satellite 103 in an orientation that maintains proper visibility from the relative navigation sensors to the client vehicle and points a fluid release output 111 at the specified target satellite. This is illustrated schematically in FIG. 4. As discussed in more detail below, in some embodiments the fluid plume can be from a thruster on the servicing satellite, where this can be one of the general use thrusters of the servicing satellite 101 or a specific thruster adapted for this purpose. Also depending on the embodiment, the thruster can be fixed with respect to body of the servicing spacecraft or movable so as to aid in aiming at a specified surface of the target spacecraft 103.

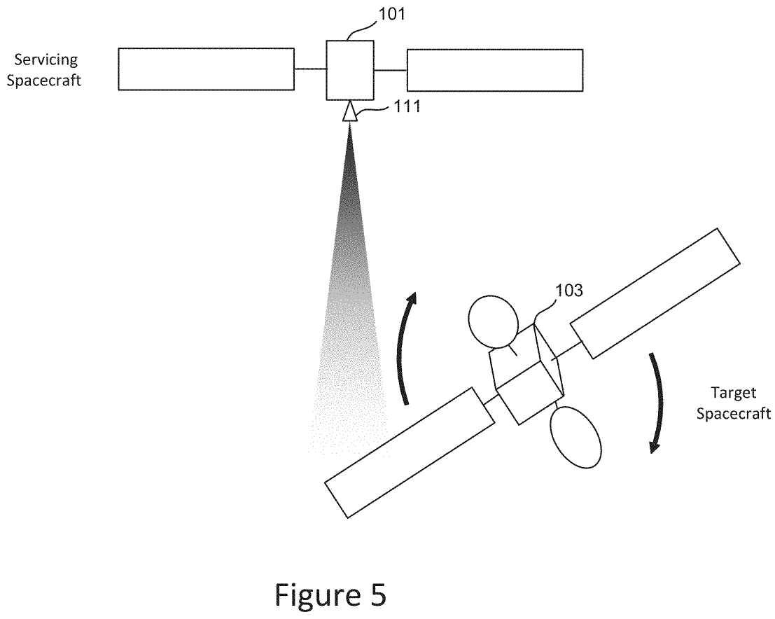

At a determined time and orientation relative to the target satellite 103, the servicing satellite 101 will begin to fire a thruster or other fluid release output 111 towards a surface of the target satellite 103, directing a plume to purposefully impinge on the target satellite. For example, as illustrated in FIG. 5, the plume of fluid is directed to impinge on a target satellite solar array, as this provides a large moment arm to generate a large amount of torque from relatively small impingement forces, maximizing the effectiveness of the plume. Firing a thruster, nozzle, or other fluid release output 111 will cause the servicing satellite to change relative position and the servicing satellite 101 can use other thrusters to counteract the impingement thruster or other fluid release output 111 in order to maintain the servicing satellite's location and orientation relative to the target satellite 103, so that the impingement thruster or other fluid release output 111 is maintained in the desired alignment. The plume is used to apply a torque to the target spacecraft 103 to reduce the vehicle dynamics of the target satellite 103 down to a rate that allows the control system of the servicing satellite 101 to manage grappling or form the target spacecraft 103 to resume operation under its own control.

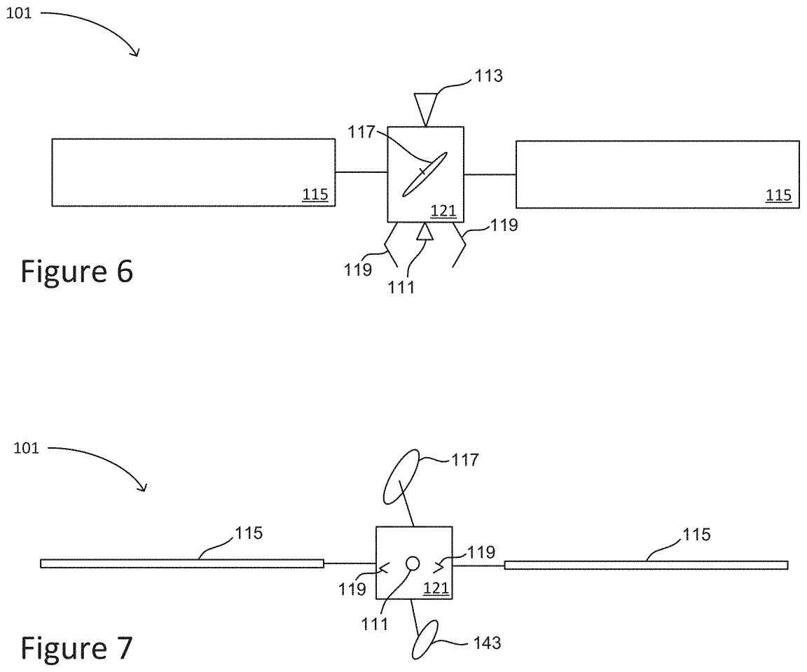

FIGS. 6-9 look at embodiments of servicing satellites in more detail. More specifically, FIGS. 6 and 7 show two views of an embodiment for a servicing satellite 101, where FIG. 6 shows a view from the same vantage point for servicing satellite 101 as in FIG. 5 and FIG. 7 shows the servicing satellite rotated by 90° about the axis of the solar arrays 115 relative to FIG. 6. A number of different embodiments are possible, but the example of FIGS. 6 and 7 can be used to illustrate some the elements relevant to the current discussion.

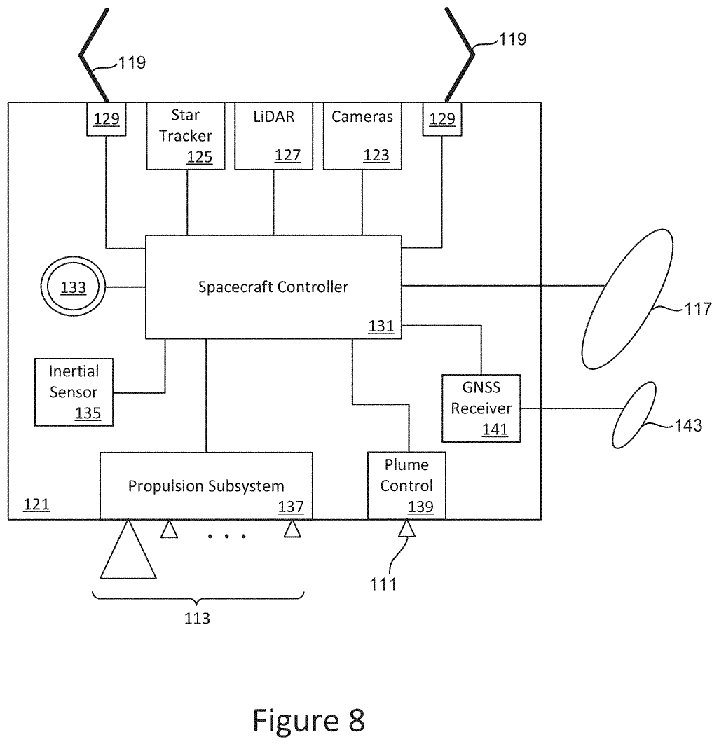

Referring to FIGS. 6 and 7, the servicing satellite 101 includes a spacecraft body 121 from which extend two, in this example, deployed solar arrays 115. Attached to the body will also be one or more number of antennae 117, which can include one or more GNSS antennae 143, by which the servicing satellite can receive and transmit signals. Depending on the particulars of the embodiment, a satellite may have a large number of antennae, but for the embodiment shown for a servicing satellite 101 shown here, only a pair of antennae for exchanging control signals related to servicing operations with a ground station are shown. Attached to the satellite body 121 are a number of thrusters, as shown at 113, which typically include one or more main thrusters and a number of attitude and orbit control thrusters, as discussed in more detail with respect to FIG. 8. Also attached to the body is one or more fluid release outputs 111 configured to emit a columnated fluid plume that can be used to mitigate tumbling of a target satellite, where the fluid release output 111 may be a thruster that also provides this function or a device specific for this purpose, depending on the embodiment. The satellite body 121 can also include one or more robotic arms 119 for use in grappling and servicing of a target satellite.

The deployed arrays 115 can include a solar array, a thermal radiating array, or both and include one or more respectively coplanar panels. The deployed arrays 115 can be rotatable about the longitudinal axis (the left-right axis in FIGS. 6 and 7), in order to achieve or maintain a desired attitude with respect to, for example, the sun. For embodiments in which the deployed arrays 115 include a solar array, the solar array may be articulable so as to be substantially sun facing. The deployed solar array 115 may be sized and positioned so as to generate substantially more power from sunlight than would be possible if the solar array was fixedly disposed on the body 121 of the servicing spacecraft 101. For example, in some implementations, the solar array orientation may be rotatable about the longitudinal axis of the servicing satellite 101 so that photovoltaic power generating surfaces of the solar array remains substantially sun facing.

The deployed arrays 115 can also be also be configured to have an angle of attack with respect to the direction of motion of the servicing spacecraft 101 such that aerodynamic drag is minimized, if operating at an altitude where this is a concern. For example, the deployed arrays 115 can be configured such that a normal to the array's surfaces is substantially orthogonal to the spacecraft's direction of motion. As the servicing spacecraft 101 travels through the atmosphere, surfaces of the deployed arrays 115 may be configured to maintain a center of aerodynamic pressure downstream of the center of mass to provide passive stability due to aerodynamic forces. The deployed arrays 115 can also be configured to provide higher stability when the fluid release output 111 applies a plume to a target satellite, such as being configured to have a relatively high moment of inertia about this center of mass. In some embodiments the solar array angle of attack with regards to solar radiation pressure can also be configured in particular orientations that provide favorable torques from solar radiation pressure (SRP).

The servicing satellite 101 can also include a servicing suite of equipment for performing servicing operations on a target satellite, including the fluid release output 111 and other apparatus such as arms or other appendages 119. Dexterous robotic arms 119 and supporting technology of the servicing suite, for example, can be used to perform a number of servicing operations. These can include high resolution inspection, anomaly resolution (e.g., solar array and antenna deployment), relocation and orbital maneuvers, upgrade installation, refueling, installation of attachable payload enabling upgrades or entirely new capabilities for existing assets. In some embodiments, the application of a plume from the servicing satellite 101 to a target satellite in order to sufficiently reduce its tumbling rate may be sufficient to restore a tumbling satellite's operation so that arms 119 or other servicing ability is not needed. This could be the case if, for example, an anomaly leaves the target satellite tumbling so rapidly that propellant is unable to be supplied to its thrusters and that, with this tumbling slowed sufficiently, it can resume normal operations without further intervention from the servicing satellite.

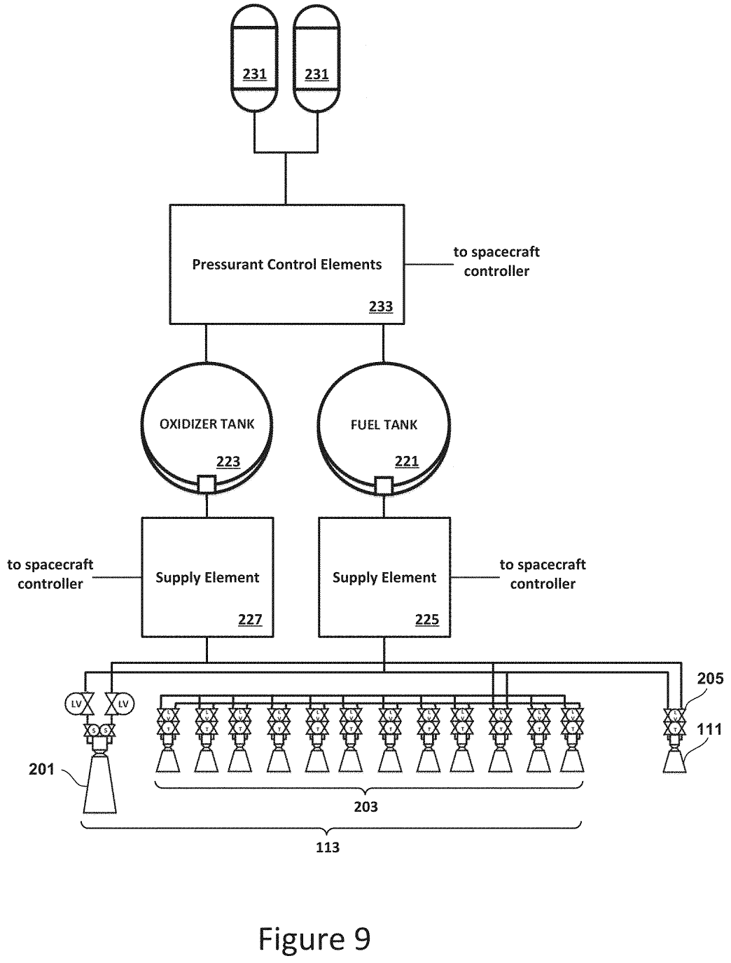

FIG. 8 is a block diagram for an embodiment of servicing satellite's body 121. Spacecraft body 121 can include a propulsion subsystem 137 and spacecraft controller 131. The spacecraft controller can include or be included in a spacecraft attitude and orbit control subsystem and is communicatively coupled with propulsion subsystem 137 and may be configured to control the operation of propulsion subsystem 137 including thrusters 113. In an embodiment, for example, propulsion subsystem 137 includes propulsion equipment, such as tankage and control and service devices and thrusters 113. The propulsion subsystem 137 is described in more detail with respect to FIG. 9.

The spacecraft controller 131 may be configured to execute, autonomously, or in response to ground command, the presently disclosed techniques of operating and servicing a target satellite, where the satellite can have one or more antennae 117 for communication with ground stations. Implementations of the subject matter described in this specification may be implemented as one or more computer programs, i.e., one or more modules of computer program instructions, encoded on non-transitory computer readable medium for execution by, or to control the operation of, a data processing apparatus, such as, for example, spacecraft controller 131.

The satellite can also be equipped with a Global Navigation Satellite System (GNSS) signal receiver 141 and corresponding GNSS antenna 143, where GNSS include the United States' Global Positioning System (GPS), Russia's GLONASS, China's BeiDou Navigation Satellite System (BDS), and the European Union's Galileo. GNSS Signal processing is typically performed in the GNSS receiver 141. A GNSS receiver 141 typically has some memory, a processor, and other components for the computation of a navigation solution given the received GNSS signal.

Still referring to FIG. 8, the body 121 of servicing spacecraft 101 can include one or more star trackers 125, inertial rate sensors (e.g., gyroscope and accelerometer) 135, or both. Inertial rate sensors 135 may include a digital integrating rate assembly (DIRA) or the like. In an embodiment, determination of spacecraft inertial attitude may be performed by spacecraft controller 131 using the output of star tracker 125 and/or inertial sensors 135. The servicing spacecraft 101 can also include one or more reaction wheels 133 that may be configured as torque actuators to control spacecraft rotation rates about one or more axes and also be used by the controller 131.

For observing a tumbling target spacecraft and performing mitigation operations, in addition to equipment for performing normal satellite operation and for the maintenance operations on a target satellite, the servicing satellite 101 can be equipped with a control system including a controller 131, 6 degree-of-freedom thruster control, cameras 123 and optics (which can include infra-red and visible light) and LiDAR (light detection and ranging) 128, in addition to star trackers 125, reaction wheels 133, accelerometers, and gyroscopes coupled with autonomous Rendezvous and Proximity Operations (RPO) software (such as that designed by the Charles Stark Draper Laboratories), for example. With these sensors, or sensor suite, and software, a servicing satellite 101 can have the capability of precise relative navigation when in close proximity to a target spacecraft.

To apply a fluid plume to mitigate tumbling of a target satellite, the satellite body 121 will also have one or more fluid release outputs 111, which will have a control system 139. In some embodiments, the fluid release output can be one of the attitude and orbit control thrusters indicated at 113 and that is controlled as part of the propulsion subsystem 137 and is configured or configurable to be used for this purpose as well as attitude and orbit control operation. In other embodiments, this impingement or fluid release output 111 can be a purpose specific thruster or nozzle for other fluid. In the embodiments where the fluid release output 111 is a thruster, the control system 139 can be incorporated in to the control system of the propulsion subsystem 137. In other embodiments, the fluid release output can release other fluid besides or in addition to the output of the thrusters of the propulsion subsystem and the satellite body 121 could incorporate storage for the fluid. For any of the embodiments, the fluid release output 111 may be fixed or aimable by its controller system 139 in response to signals from the controller 131.

The satellite body 121 can also include control mechanisms 129 for robotic arms 119, which can be formed of multiple links connecting a number of joints, or other devices for use in servicing a target satellite. The control mechanisms 129 can include servos, actuators, and other elements to move and control the robotic arms 119 or other devices in response to the controller 131. These operations can be based on input from the ground, autonomous, or a combination of these and can use input for the cameras 123 and LiDAR 127, for example.

FIG. 9 provides more detail on an embodiment of the propulsion subsystem 137 and thrusters 113. In the embodiment of FIG. 9, the impingement or fluid release output 111 and its controller system 139 and fluid source is incorporated in the propulsion subsystem 137.

The thrusters 113 can include one or more more powerful thrusters 201 arranged to be the primary source of thrust to move the servicing satellite 101, plus a number of attitude and orbit control thrusters 203 used to make finer adjustments when moving the servicing satellite 101 and stabilize the satellite during both movement and performing servicing operations, including the application of a fluid plume to a target satellite from the fluid release output 111. For example, referring back to FIGS. 6 and 7, a primary thruster could be placed on the service satellite's body 121 as shown at 113 on the side opposite the fluid release output 111. The additional attitude and orbit control thrusters 203 (not shown in FIGS. 6 and 7) could then be distributed on the various surfaces of the satellite body to provide control and maneuverability. The representation of the primary thruster 201, attitude and orbit control thrusters 203, and the impingement or fluid release output 111 as arranged along a line in FIG. 9 is only meant to simplify the schematic representation and not meant to be representative of their placement on the satellite body 121.

In the embodiment of FIG. 9, the primary thruster 201, attitude and orbit control thrusters 203, and the impingement or fluid release output 111 are fed through valves (such as indicated at 205 for the fluid release output 111 thruster and which can be connected to and controller by the spacecraft controller 131) by a fuel tank 221 and an oxidizer tank 223 by way of respective supply elements 225, 227. The supply elements can include the various valves, filters, pressure transducers, fill/drain valves for the fuel tank 221 and the oxidizer tank 223, and other elements commonly used in a propulsion subsystem 137 and are connected to spacecraft controller 131 for the maneuvering of the servicing spacecraft. In other embodiments, the servicing spacecraft 101 can have a monopropellant propulsion system in which a single propellant can provide thrust through means of chemical decomposition. Although not illustrated in FIG. 9, the thrusters (201, 203), as well as the fluid release output 111, are also connected to and individually controllable by the spacecraft controller 131 for maneuvering and controller of the spacecraft.

The propulsion subsystem 137 can also include pressurant tanks 231 connected to the fuel tank 221 and the oxidizer tank 223 though the pressurant control elements 233. The pressurant control elements 233 can include valves, filters, pressure transducers, pressure regulators, fill/drain valves for the fuel tank 221 and the oxidizer tank 223, and other elements commonly used in a propulsion subsystem 137 and can connected to spacecraft controller 131 to control the application of pressurant.

The embodiment of FIG. 9 illustrates an example where the fluid release output 111 is a thruster, in this case a specified impingement thruster, although in other embodiments one or more of the attitude and orbit control thrusters 203 can alternately, or additionally, be used for this purpose. In other embodiments, the fluid release output 111 can alternately, or additionally, include a separate system with a separate control system and fluid supply for use in mitigated the tumbling of a target satellite.

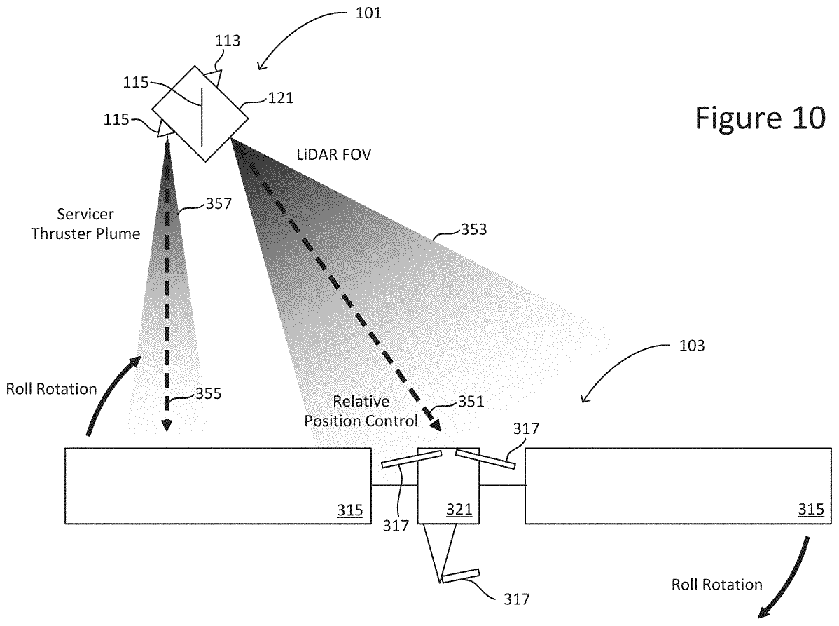

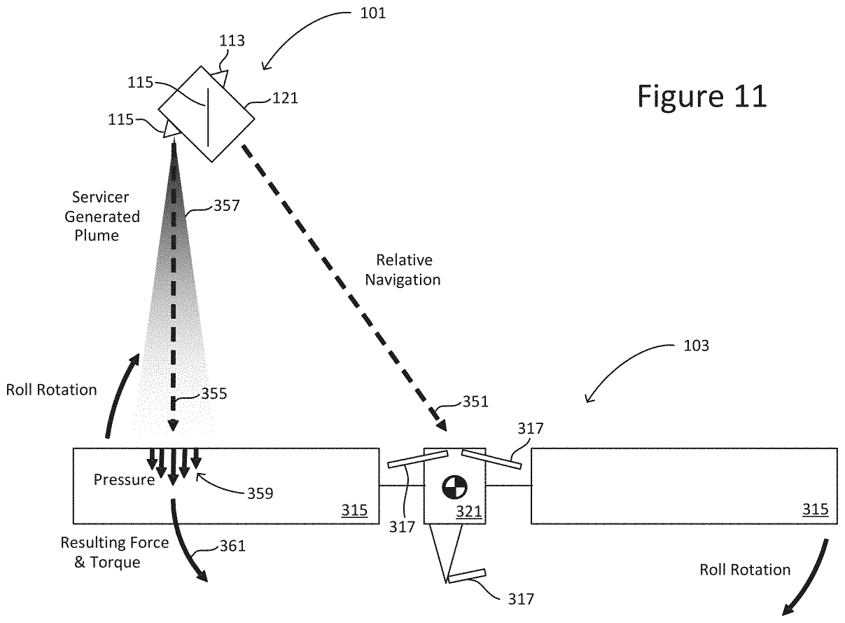

The embodiments described with respect to FIGS. 5-9 can be used for the relative navigation control to accurately position the servicing satellite 101 at a safe standoff distance in a relative orientation that can point the fluid release output vector toward a specified surface of the target satellite 103 at a specified instance in time. For many target spacecraft in geosynchronous orbit, “roll” (rotation in the plane of the page of FIG. 6, where the axis of rotation is coming out of the plane of the page) is that axis that will have the greatest moment of inertia. Because of this, a tumbling spacecraft is often expected to be found rolling. In such a rolling mode, a target spacecraft's arrays will likely be pointing along the axis of rotation, meaning that the arrays will be rotating edge-on like a swinging knife. Pitch and yaw rotation rates can also be mitigated using the techniques presented here, but roll is the most likely scenario. FIGS. 10 and 11 respectively illustrate a servicing satellite 101 positioning itself relative to a target satellite 103 and operating, or firing, the fluid release output 111 to purposefully impinge a surface of a target satellite 103.

In FIG. 10, a target satellite 103 is the client vehicle to be serviced by the servicing satellite 101. In the example of FIG. 10, the target satellite 103 could be, for example, a communication satellite with a number of antennae 317, although the mitigation technique can be applied broadly to differing types of satellites. For a given client vehicle or target satellite 103, there will be differences as to the satellites size, geometry, mass, mass distribution and other factors that can affect the dynamics of a tumbling satellite. These factors will also affect the surfaces on the tumbling satellite 103 that are available for the impingement of a fluid plume from the servicing satellite 101. The structure of the satellite, including factors such at the material of which it is constructed will also affect the intensity of the mitigation plume that can be applied without inflicting an unacceptable amount of damage to the surface upon which the plume is incident. Consequently, for a given target satellite, details such the duration, intensity, focusing and other details may be adjusted, but the general concepts illustrated in the examples here can applied. In the example of FIG. 10 the target satellite has an array 315 extending from either side of the body 321 and is rolling in the plane of the page about an axis extending into the page.

A mission for the servicing satellite 101 may be one mission or one of several missions for which it has been specifically launched, or the servicing satellite may already be active and receive a new mission. Depending on the embodiment and the particulars of a given servicing operation, the servicing satellite may be guided from ground, autonomous, or some mixture of these, such as guided to within a certain range of a target satellite 103 and then position itself using its relative position control. For example, the servicing satellite 101 might receive by way of its RF communication a location of a client vehicle to be the target satellite 103 based on a location and altitude, or position, velocity, and time, that would allow the servicing satellite 101 to navigate to the vicinity of the target satellite 103. If the target satellite 103 has experienced an anomaly, it may be out of communication and its location may be only approximately known. For example, the NORAD (North American Aerospace Defense Command) TLE (Two-Line Element) could be used to approximate the target spacecraft's location. It may be known ahead of time that the target satellite 103 is tumbling, or the servicing satellite 101 may show up for a servicing mission and find this to be the case.

Once the servicing spacecraft 101 is fairly close (for example, with 20 km or so) to the target spacecraft 103, the servicing spacecraft 101 can use its LiDAR, cameras, and other sensing and positioning systems to enter into close proximity to the target satellite 103 and position itself at a standoff distance for observation of the target satellite 103 and for relative position control to align itself with the target satellite 103. For example, as illustrated in FIG. 10 the LiDAR from the servicing satellite's body 121 can be aligned with the target satellite's body 321 along axis 351, where the LiDAR field of view (FOV) is represented schematically at 353. The servicing satellite 101 can then observe the target satellite to determine its location, the amount of tumbling, and available surfaces if mitigation is required. If the rotation of the target satellite 103 is slow enough, the servicing satellite 101 may be able to grapple without mitigation of the rotation through use of its positioning control. If tumbling mitigation is to be used, the servicing satellite can use its LiDAR and other systems to determine a surface of the target satellite 103 to which the plume is to be applied, along with characteristics of the plume. In the example of FIG. 10, the servicing satellite 101 has aligned the thruster or other fluid release output 111 to be aimed along the axis 355 for the plume 357 to impinge on an edge of array 315 rolling toward the servicing satellite.

FIG. 11 illustrates the dynamics of the tumbling mitigation. The servicing satellite 101 uses its positioning and sensing mechanisms to navigate to maintain its relative position along the axis 351 with the target satellite 103. In addition to maintaining a relative position based on the movement of the target satellite 103, the servicing satellite 101 will use its relative navigation ability to counteract the force due to the plume 357. For example, one or more of the attitude and orbit control thrusters, such as illustrated by the thruster 113 on the face of servicing satellite body 121 opposite the face with fluid release output 111, to provide an opposing force to the center of mass of servicing satellite 101.

In the example of FIG. 11, the target satellite 103 is rolling clockwise about its center of mass in plane of the page. Here the center of mass is shown to be at the center of the spacecraft body 321, but this may not be the case even if the target satellite has a symmetric design as the anomaly may be related to an array not fully deploying, for example, and the target satellite may exhibit a more complex behavior than the illustrated propeller-like roll. In many cases, though, the servicing satellite can use its relative navigation to align itself along the axis 351 relative to the center of target satellite body 321 and in the plane of the target satellite's rotation. In the example of FIG. 11, the axis 355 for the fluid release output 111 is aligned so that the plume 357 will impinge on the thin edge of array 315 near its end. The surface selected for the plume 357 to impinge upon will depend on the rotational mode of the target satellite 103 and the available surfaces. A target satellite will typically have one or more deployed arrays 315 and rolling will often be the tumbling mode, so that an array provides an impingement surface with a relatively good moment arm relative to the target satellite's center of mass.

The pressure exerted by the plume 357 on the edge of the target satellite's array 315 is represented at 359. The pressure 359 exerts a resultant force along the edge of the array, providing a torque represented at 361 to counteract the roll rotation of the target satellite 103. The greater the intensity of the plume 357 emitted by the fluid release output 111, the greater the resultant torque and the more quickly the tumbling will be mitigated, but this should be balanced against the possibility of damaging the target spacecraft 103, as the array 315 or other available impingement surface may be delicate in terms of structure, heating, and so on.

According to the embodiment, the servicing satellite 101 may be able to vary the intensity of the plume, the diameter of the plume, or other characteristics in addition to the duration of the plume 357. The details of the plume may be varied based upon observation of the target satellite 103 by the servicing satellite 101, information on the target satellite 103 provided to the servicing satellite 101 from the ground, or some combination of these. For example, the servicing satellite 101 may be communicated information from the ground on the intensity of a plume that a particular target satellite's array can withstand without suffering significant degradation based information concerning the target satellite's construction details.

The plume 357 can be applied as one or more pulses of fixed duration, one or more pulses of a variable duration, or a combination of these, where an open loop or closed loop implementation can be used. For example, in an open loop implementation, a fixed duration pulse can be applied in response to an instruction from the ground and as determined by the servicing satellite's controller. Subsequent to the application of the fixed duration pulse, the servicing satellite 101 can use its LiDAR or perform other determination of whether the tumbling has been sufficiently mitigated to perform grappling or other subsequent servicing operations or if instead another plume pulse should be applied, where the determination can either be determined from the ground or autonomous.

In a closed loop embodiment, the servicing satellite 101 applies a continuous plume or sequence of pulses to the target satellite 103 while using its LiDAR and/or other sensors to monitor the target satellite's state to determine when the amount of tumbling is sufficiently abated. In either a closed loop or open loop embodiment, as the target satellite 103 rolls, the selected impingement surface may not be available at certain positions (e.g., when the target satellite 103 has rotated 90° relative to the shown view) and the servicing satellite 101 may suspend the plume until a surface is again available.

For example, a tumbling satellite may have a rotation rate of a few degrees per second. For a moderate sized satellite, a plume applied to an array for the satellite might provide a force of around a tenth of a Newton to a few Newtons, depending on how the plume impinges on the array. For a two second pulse duration, depending on the geometry and other characteristics of the target satellite 103, this could slow the rotation rate by a few hundredths to a whole degree per second of rotation.

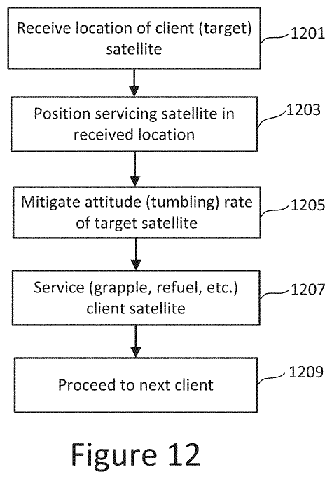

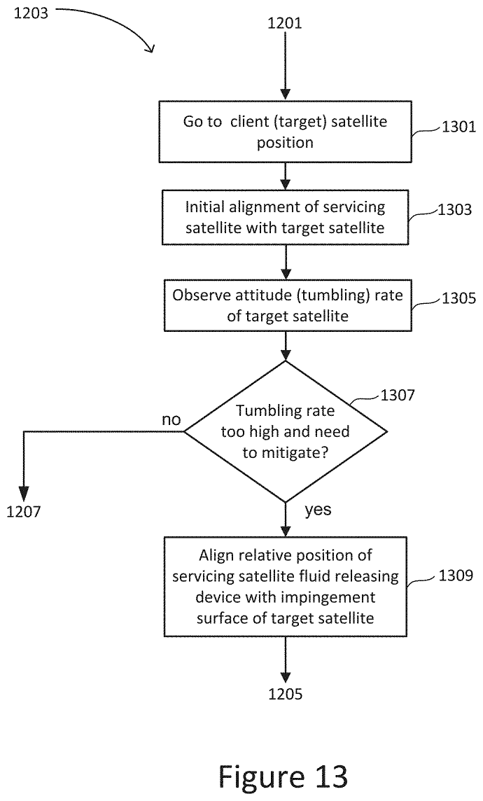

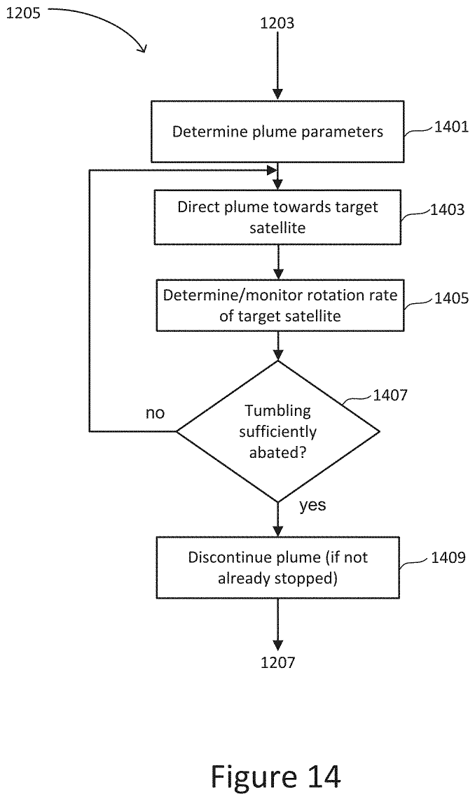

FIG. 12 is a flowchart illustrating an embodiment of a process for the use of a servicing satellite for a servicing mission for a client satellite. FIGS. 13 and 14 are flowchart illustrating embodiments for details of FIG. 12.

More specifically, FIG. 12 begins at step 1201 with a servicing satellite 101 receiving a position of a client (target) satellite 103. The servicing satellite 101 may already have a mission list when launched, receive missions once launched, or update a previous mission list once launched to, for example, add in higher priority missions to its current list. The position of a client satellite can be provided by, for example, a set of GPS (or, more generally, GNSS) based coordinates for the client's angular position and an altitude. In a typical implementation used on a spacecraft, GPS systems use position, velocity, and time in a WGS84 (World Geodetic System, 1984 revision) frame that is an earth fixed frame. The position of a client is typically supplied in an Earth-Centered Inertial (ECI) frame. The supplied position will have a varying degree of accuracy since if a client has experienced an anomaly it may no longer be in communication and its position may be approximated from tracking information, such as calculated from a NORAD Two-line Element set (TLE).

In step 1203, the servicing satellite 101 moves into position relative to a client (target) satellite 103. The positioning of the servicing satellite 101 can be controlled from the ground, an autonomous operation, or a combination of these. For example, the servicing satellite 101 can be controlled from the ground to bring it into proximity to a target satellite 103, after which the servicing satellite 101 can identify the target satellite 103 and use its cameras 123, optics, LiDAR 127 and other systems to align itself using its relative positioning capabilities. Step 1203 is considered in more detail in FIG. 13.

If the target satellite 103 is tumbling at too high a rate to readily permit grappling or other servicing, the servicing satellite 101 can perform mitigation at step 1205. Step 1205 is considered in more detail in FIG. 14. In some case, abating the tumbling may be sufficient to restore operation of the target satellite 103. For example, if an anomaly caused the target satellite 103 to begin tumbling so rapidly that its unable to supply propellant to its attitude and orbit control thrusters 203, once its tumbling is slowed sufficiently it may be able use its attitude and orbit control thrusters 203 to fully restore stability and resume normal operation.

Once any needed mitigation of tumbling is performed, as step 1207 the servicing satellite 101 grapples the target satellite 103 and performs one or more service operations, such as inspection, anomaly resolution, refueling, repairs, and so on, using the dexterous robotic arms 119 and other elements of a servicing suite. Once finished, at step 1209 the servicing satellite 101 can stand off and proceed to the client or wait for further instructions.

FIG. 13 is flowchart providing more detail for an embodiment of step 1203 of FIG. 12 and is represented schematically in FIG. 10. The servicing satellite 101 uses its guidance, navigation, and control system to go to the specified position to be in proximity of the client (target) satellite 103 at step 1301. Depending on the state of the target satellite 103, the accuracy of the target satellite's position may vary quite a bit. For example, if the target satellite 103 have been out of communication for some time due to an anomaly, the ground may not have had an accurate fix on the target satellite's position for a prolonged period and only estimated based on its position and trajectory at the time of the anomaly, where, for example this can be estimated based on satellite tracking data supplied by NORAD. Depending on the embodiment, the servicing satellite 101 may be controlled from the ground to be positioned near the target satellite 103, or supplied with a position, such as GPS coordinates and an altitude, and proceed to the position autonomously.

Once in proximity to the target satellite 103, the servicing satellite 101 can use its cameras 123, optics, LiDAR 127 and other systems for relative position control to perform an initial alignment of itself with the target satellite 103 at step 1303. The initial alignment can place the target satellite 103 at a close, but safe stand-off distance from target satellite 103. This standoff distance can be an approximate distance that would be used for applying the plume, but far enough away that the servicing satellite 101 would not be damaged by a tumbling client.

Once in the initial alignment position, at step 1305 the service satellite 101 can use its LiDAR 127 and other systems to observe the target satellite 103 to determine whether the target satellite is tumbling at a rate that would require, or be easier if, mitigation is performed before any servicing is performed. For example, if the target satellite 103 is tumbling with a first rotation rate greater than, for example, 0.5 deg/s, it may be determined that mitigation is needed before grappling can be performed. The value of the first rotation rate can be based on the capabilities of the servicing satellite 101, the mass or other properties of the target satellite, or other parameters. At step 1307 this determination process can be performed autonomously by the spacecraft controller 131 using its systems, under control from the ground, or by the spacecraft controller 131 in conjunction with the ground. If there is no tumbling, or it is of a manageable amount, the flow can go to step 1207 for a servicing operation.

If step 1307 determines that the servicing satellite is to perform tumbling mitigation, based on the observation of step 1305, at step 1309 the servicing satellite can use its relative position control align itself so that its fluid release output 111 is align with an impingement surface of the target satellite. The selection of the impingement surface can be based on the servicing spacecraft's observation, previously received information on the target spacecraft 103, instructions from the ground, or combinations of these. For optimal effectiveness, the alignment of the fluid release output 111 will direct the plume to be along an axis lying in or near the plane of rotation for the target satellite and at a maximum distance to provide the largest moment arm. Once aligned, the flow proceeds to step 1205.

If tumbling mitigation is to be performed, this is performed in step 1205, where FIG. 14 is flowchart providing more detail for an embodiment of step 1205 of FIG. 12 and is represented schematically in FIG. 11. Beginning at step 1401, the plume parameters are determined or set. These parameters can include the intensity of the plume, a pulse duration, and aiming/focusing of the plume 357 to be discharged from the thruster or other fluid release output 111. Depending on the embodiment, these can be preset parameters that spacecraft controller 131 has stored in memory, based on the observation of the target spacecraft 103 at step 1305, be received from the ground, or a combination of these.

At step 1403, the thruster or other fluid release output 111 applies the plume 357 to the target satellite 103. Depending on the embodiment, this can be a single pulse of fixed duration, such as the 2 second pulse mentioned above, a sequence of pulses, or a continuous plume. While the servicing spacecraft 101 is applying the plume 357, the force on the servicing spacecraft 101 caused by the emission of the plume can be offset by the servicing spacecraft's relative position control using the attitude and orbit control thrusters, such as illustrated at 113 in FIG. 11, to counterbalance the fluid release output 111.

While, or after, applying the plume 357, at step 1405 the servicing spacecraft 101 can use its LiDAR 127 and other system to monitor the effect on the target spacecraft 103 at step 1405. A number of embodiments are possible, including open loop and closed loop implementations. In an open loop implementation, for example, a plume of a pre-determined duration could be applied, after which at step 1407 it can be determined if the tumbling has been sufficiently mitigated. If it is determined, either by the servicing satellite or based on instruction from the ground, that the tumbling rate is still too high, the flow can loop back to step 1403 for another pulse.

In a closed loop embodiment, the monitoring at step 1405 is performed while applied a continuous plume or a sequence of pulses, with the degree of mitigation checked at step 1407, and the loop back through steps 1403, 1405, and 1407 continuing until a sufficient degree of mitigation is determined at step 1407. As the target satellite 103 tumbles, the servicing satellite's spacecraft controller 131 may determine a pause based on the attitude if a suitable impingement surface is not available, resuming once the target satellite again presents a suitable surface.

For either closed loop or open loop embodiment, once step 1407 determines that the rate of tumbling has sufficiently abated, for example to a rate that allows grappling, the plume, if not already stopped, can be stopped at step 1409. The determination of step 1407 can be based on a second rotation rate that is the same as the first rate used in step 1307, or a somewhat lower rate, since if tumbling mitigation is to be used, it may be more efficient to slow the rate of tumbling to a lower rate. The flow then continues on to the servicing of step 1207 of FIG. 12.

The techniques described above describe the use of a fluid from a first, servicing spacecraft to affect the dynamics of a second, target or client spacecraft. The servicing spacecraft can use the sensors and software of its relative navigation system to precise controlling its relative position and orientation while applying a fluid plume to the target spacecraft.

In a first set of embodiments, a satellite includes a propulsion subsystem, one or more sensors, and a fluid release output. The satellite also includes a satellite controller connected to the propulsion system, the one or more sensors and the fluid release output. The satellite controller is configured to position and align the satellite relative to a second satellite by use of the propulsion subsystem, to apply a plume of fluid from the fluid release output to a surface of the second satellite, and to determine from one or more of the sensors an attitude of the second satellite in response to applying the plume of fluid.

In other embodiments, a method includes positioning a first satellite in proximity to a second satellite and aligning a fluid release output of the first satellite with a surface of the second satellite. A plume of fluid is directed from the fluid release output toward the surface of the second satellite. A rate of rotation is determined for the second satellite in response to directing the plume of fluid from the fluid release output toward the surface of the second satellite.

In further embodiments, a satellite includes a communication antenna, a propulsion subsystem, and a sensor suite. The satellite also includes a servicing suite configured to perform a servicing operation on a client satellite. The satellite includes a satellite controller connected to the communication antenna, propulsion subsystem, sensor suite and servicing suite. The satellite controller is configured to receive a location for a client satellite through the communication antenna, locate the satellite in proximity to the client satellite by use of the propulsion subsystem, and to perform a specified service operation on the client satellite with the servicing equipment, the service operation including determining by the sensor suite whether the client satellite is rotating too rapidly to perform the service operation and, in response, performing an operation to mitigate the rotation of the client satellite prior to performing the service operation.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for Identification purposes to Identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

What is claimed is:

1. A satellite, comprising:
a propulsion subsystem;
one or more sensors;
a fluid release output; and
a satellite controller connected to the propulsion subsystem, the one or more sensors and the fluid release output, the satellite controller configured to position and align the satellite relative to a second satellite by use of the propulsion subsystem, to apply a plume of fluid from the fluid release output to a surface of the second satellite, and to determine from one or more of the sensors an attitude of the second satellite in response to applying the plume of fluid.

2. The satellite of claim 1, wherein the propulsion subsystem comprises:
one or more attitude and orbit control thrusters, wherein the satellite controller is configured to maintain by use of attitude and orbit control thrusters a relative position of the satellite with respect to the second satellite while applying the plume of fluid from the fluid release output to the surface of the second satellite.

3. The satellite of claim 1, further comprising:
one or more communication antennae, wherein the satellite controller is configured to receive a location for the second satellite through the one or more communication antennae and navigate the satellite to the location by use of the propulsion subsystem.

4. The satellite of claim 1, further comprising:
one or more robotic arms configured to perform a servicing operation on the second satellite.

5. The satellite of claim 1, wherein the satellite controller is configured to monitor the attitude of the second satellite and to apply the plume of fluid to the surface of the second satellite in response to determining that the second satellite is rotating at a rate greater than a first level.

6. The satellite of claim 5, wherein the satellite controller is configured to monitor the attitude of the second satellite and to stop applying the plume of fluid to the surface of the second satellite in response to determining that the second satellite is rotating at a rate less than a second level.

7. The satellite of claim 1, wherein the fluid release output is configured to apply the plume of fluid as a sequence of pulses.

8. The satellite of claim 1, wherein the fluid release output is a thruster.

9. The satellite of claim 1, wherein the one or more sensors include a light detection and ranging (LiDAR) sensor.

10. A method, comprising:
positioning a first satellite in proximity to a second satellite;
aligning a fluid release output of the first satellite with a surface of the second satellite;
directing a plume of fluid from the fluid release output toward the surface of the second satellite; and
determining a rate of rotation for the second satellite in response to directing the plume of fluid from the fluid release output toward the surface of the second satellite.

11. The method of claim 10, further comprising:
maintaining an alignment of the fluid release output relative to the second satellite while directing the plume of fluid from the fluid release output.

12. The method of claim 11, wherein the first satellite comprises one or more attitude and orbit control thrusters whereby the first satellite maintains the alignment of the fluid release output relative to the second satellite.

13. The method of claim 10, wherein the fluid release output is a thruster.

14. The method of claim 10, further comprising:
subsequent to positioning the first satellite in proximity to the second satellite, monitoring an attitude of the second satellite by the first satellite, where in aligning the fluid release output is based on the monitoring of the attitude of the second satellite.

15. The method of claim 10, wherein determining the rate of rotation for the second satellite in response to directing the plume of fluid from the fluid release output toward the surface of the second satellite includes:
monitoring the rate of rotation for the second satellite while directing the plume of fluid toward the surface of the second satellite; and
discontinuing the plume of fluid in response to the rate of rotation for the second satellite sufficiently abated.

16. The method of claim 10, wherein determining the rate of rotation for the second satellite in response to directing the plume of fluid from the fluid release output toward the surface of the second satellite includes:
subsequent directing the plume of fluid toward the surface of the second satellite, determining whether the rate of rotation for the second satellite is sufficiently abated; and
in response to determining that the rate of rotation for the second satellite is not sufficiently abated, further directing the plume of fluid toward the surface of the second satellite.

17. The method of claim 10, further comprising:
in response to determining that the rate of rotation for the second satellite is sufficiently abated, performing by the first satellite of a service operation on the second satellite.

18. The method of claim 10, wherein the plume of fluid is a sequence of pulses.

19. A satellite, comprising:
a communication antenna;
a propulsion subsystem;
a sensor suite;
a servicing suite configured to perform a servicing operation on a client satellite; and
a satellite controller connected to the communication antenna, propulsion subsystem, sensor suite and servicing suite, the satellite controller configured to receive a location for a client satellite through the communication antenna, locate the satellite in proximity to the client satellite by use of the propulsion subsystem, and to perform a specified service operation on the client satellite with the servicing equipment, the service operation including determining by the sensor suite whether the client satellite is rotating too rapidly to perform the service operation and, in response, performing an operation to mitigate rotation of the client satellite prior to performing the service operation.

20. The satellite of claim 19, wherein the servicing suite includes:
a fluid release output, and wherein the operation to mitigate the rotation of the client satellite includes applying a plume of fluid from the fluid release output to a surface of the client satellite.
